(19) United States
(12) Patent Application Publication
(10) Pub. No.: US 2008/0164449 A1
(43) Pub. Date: Jul. 10, 2008

(54) PASSIVE RESTRAINT FOR PREVENTION OF UNCONTROLLED MOTION

(76) Inventors: Joseph L. Gray, St. Joseph, MO (US); Ralph S. McKee, St. Joseph, MO (US)

Correspondence Address: SHUGHART THOMSON & KILROY, PC, 120 WEST 12TH STREET, KANSAS CITY, MO, 64105, US

(21) Appl. No.: 11/970,856

(22) Filed: Jan. 8, 2008

Related U.S. Application Data
(60) Provisional application No. 60/879,395, filed on Jan. 9, 2007.

(51) Int. Cl. B66F 11/00; F16F 9/10

(52) U.S. Cl. 254/93 R; 188/288

(57) ABSTRACT

A passive energy absorbing strut for dynamic restraint includes a hydraulic cylinder, a hydraulic piston rod extending from the cylinder, a rod stem on the end of the rod and having a flange and a stop at opposite ends, a floating piston member sleeved on the stem between the flange and the stop, the piston member having fluid passages therethrough, and a piston spring urging the piston member away from the flange. The flange is sized to restrict the piston passages when the piston member engages the flange. The piston member is driven toward the flange in reaction to initiation of sudden extension of the strut, thereby restricting the piston passages and the flow of hydraulic fluid therethrough. The strut is connected between a piston and cylinder of a pneumatic vehicle end lift to damp sudden extension of the lift in response to loss of the load.

### CROSS-REFERENCE TO RELATED APPLICATION

This application claims priority under 35 U.S.C. 119(e) and 37 C.F.R. 1.78(a)(4) based upon copending U.S. Provisional Application Ser. No. 60/879,395 for ENERGY ABSORBING STRUT FOR DYNAMIC RESTRAINT, filed Jan. 9, 2007, which is incorporated herein by reference.

### BACKGROUND OF THE INVENTION

The present invention is generally directed to pneumatic vehicle end lifts and, more particularly, to such an end lift incorporating an internal energy absorbing strut for dynamic restraint to resist sudden or uncontrolled extension of the lift in response to accidental loss of the load.

The need to lift vehicles for service work is well established and has been implemented by both permanent and mobile lift devices. Upright mobile end lift devices for engaging a bumper of a vehicle to lift the end of the vehicle for service are well known. A particular problem with pneumatic end lifts is that a sudden loss of the load can cause a sudden expansion of the fluid within the lift cylinder, resulting in sudden extension of the cylinder which can cause the entire lift to jump from the floor when the cylinder reaches the end of its stroke. Such an occurrence can be hazardous to nearby personnel and may be damaging to the lift device, to vehicles and equipment in the vicinity, or to the floor or pavement.

Thus, there is a need for a restraint mechanism for pneumatic lifts, and other pneumatic devices, which prevents sudden extension of the cylinder in response to loss of load, but which does not interfere with normal operation of the pneumatic cylinder. Preferably, such a restraint mechanism is incorporated within the pneumatic cylinder.

The purpose of the restraint mechanism is to absorb excess energy in the abnormal condition of a sudden load loss, yet not interfere with normal operation of lifting loads that are securely supported by the lift. While a sudden load loss is rare and not predictable, the abnormal event can take place at any position along the stroke of the lift. This requires the restraint mechanism to be ready to act dependably at any time throughout the life of the lift and at any height during the raising, holding, or lowering of the vehicle. These lifts have demonstrated useable lives in the range of 40 years, and typically maintenance and servicing of the lift is spotty to non-existent. Because some load losses occur with 20 year old or older equipment, it is imperative that the functional dependability of the restraint be very high over prolonged periods of time, even with minimal maintenance or servicing. Because the restraint is not active during ordinary usage, but only during load loss, a mechanic would have no warning if the restraint had gone bad.

Conventional hydraulic dampers, commonly referred to as “shock absorbers” in relation to automobiles, could be utilized as a restraint mechanism for pneumatic lifts. A typical shock absorber damps sudden movement by restricting the flow of a liquid from one chamber to another through an orifice as the shock absorber strokes inward or outward. If the restriction is fixed, a shock absorber sized appropriately for the abnormal condition of a sudden loss of load would likely introduce drag or other negative characteristics during operation of the lift device under normal conditions. What is needed then is a hydraulic restraint device which is inactive during normal conditions, but which activates instantly if load loss occurs.

The Watson U.S. Pat. No. 3,621,949 and the Jensen U.S. Pat. No. 5,667,041 both show shock absorbers which change the flow passages toward the fully extended conditions of the shock absorbers; that is, the flow passages are more restricted toward the end of the extension stroke. While the incorporation of such arrangements within a pneumatic lift device might be possible, they do not provide a capability of changing between the restriction sizes at any random position of the pneumatic cylinder between retracted and almost fully extended.

### SUMMARY OF THE INVENTION

The present invention generally provides a passive dynamic restraint arrangement for selectively restricting flow of pressurized fluid within a cylinder through passages of a floating piston head to thereby restrain sudden relative movement between the cylinder and a piston rod having the piston floating thereon.

More particularly, the present invention provides an energy absorbing strut for dynamic restraint of a pneumatic cylinder, such as a pneumatic lift cylinder. An embodiment of the restraint apparatus of the present invention is a hydraulic device which is positioned within a pneumatic cylinder and which extends and retracts therewith. The restraint device has two chambers between which a hydraulic fluid flows during expansion and extension of the mechanism. The end lift device has a vertically oriented pneumatic linear motor in which the piston is connected to a ground engaging base and the cylinder is connected to a vehicle lift assembly adapted for engagement with a bumper of a vehicle. The end of the vehicle is lifted by extension of the pneumatic cylinder and lowered by retraction thereof.

During normal gradual extension and retraction of the pneumatic lift cylinder, fluid flows freely between the chambers of the restraint device, to prevent interference with the normal operation of the pneumatic cylinder. However, if the pneumatic cylinder begins to suddenly extend, the passive restraint device will activate to limit the rate of extension of the pneumatic cylinder. The pneumatic cylinder may still extend; however, it can be designed such that vertical movement is limited to occur within current applicable standards. The restraint mechanism is configured in such a manner that it can function at any position along the stroke of the pneumatic cylinder.

In an exemplary embodiment of the invention, the energy absorbing strut includes a hydraulic strut cylinder connected to the pneumatic cylinder and having a strut piston rod extending therefrom and connected to the pneumatic cylinder rod, the strut piston rod terminating within the strut cylinder in an end flange spaced from a stop. A floating piston head is sleeved on the strut piston rod between the end flange and the stop. The piston separates the strut cylinder into two chambers and has axial passages therethrough to enable hydraulic fluid to flow between the chambers as the strut is extended and retracted. A piston spring is positioned on the strut piston rod and normally urges the piston away from the flange. In the normal position of the piston, fluid can freely flow through the piston passages. However, when the piston engages the flange, flow through the piston passages is highly restricted.

In normal, gradual operation of the pneumatic cylinder, the passive energy absorbing strut has no effect on extension or retraction of the pneumatic cylinder, as hydraulic fluid freely flows through the piston passages. If the load is suddenly lost during extension of the pneumatic cylinder, the compressed air within the pneumatic cylinder suddenly expands without the restraint of the load, causing the pneumatic cylinder to abruptly start to extend. In turn, the sudden extension of the pneumatic cylinder causes the passive restraint strut to start to suddenly extend. This causes a pressure differential between the chambers of the strut which overcomes the bias of the piston spring and urges the piston into engagement with the flange, thus restricting flow through the piston passages. The restricted flow between the chambers of the strut prevents the pneumatic cylinder from uncontrollably extending. The pneumatic cylinder will continue to extend, but at a controlled rate until equilibrium is reached within the pneumatic cylinder. When equilibrium is reached, the pressure differential between the strut chambers subsides, and the piston spring again urges the piston away from the flange, thereby returning the strut to standby or passive status, making normal use of the lift possible. In this condition, the mechanic can lower the pneumatic lift and again engage the end of the vehicle to be lifted. Engagement of the floating piston with the flange during sudden extension can also be affected by inertia of the piston and/or friction between the piston and the inner walls of the strut cylinder.

Other objects and advantages of the present invention will become apparent from the following description taken in conjunction with the accompanying drawings wherein are set forth, by way of illustration and example, certain embodiments of this invention.

The drawings constitute a part of this specification and include exemplary embodiments of the present invention and illustrate various objects and features thereof.

### BRIEF DESCRIPTION OF THE DRAWINGS

FIG. 1 is a cross-sectional view of a pneumatic vehicle end lift device incorporating a passive restraint apparatus which embodies the present invention.

FIG. 2 is a longitudinal cross sectional view at an enlarged scale and showing details of the passive restraint.

FIG. 3 is a greatly enlarged cross-sectional view of an end of the passive restraint and illustrates details thereof.

FIG. 4 is a view similar to FIG. 3 and illustrates the relationship of a floating piston and end flange of the strut during normal, gradual operation of the vehicle end lift.

FIG. 5 is a view similar to FIG. 3 and illustrates the relationship of the floating piston and end flange to restrict flow through axial piston passages in response to abrupt extension of the vehicle end lift, for example by accidental loss of a load being lifted by the lift device.

### DETAILED DESCRIPTION OF AN EXEMPLARY EMBODIMENT

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Referring to the drawings in more detail, the reference numeral 1 generally designates a passive restraint apparatus for prevention of uncontrolled motion which is an embodiment of the present invention. The restraint or strut apparatus 1 functions to allow gradual movement between two members, such as a piston 2 and a cylinder 3 of a pneumatic linear motor 4, but which retards sudden movement therebetween. In the illustrated embodiment, the pneumatic motor 4 is incorporated within an automotive end lift device 5 to prevent sudden and uncontrolled extension of the pneumatic motor 4 in the event that a load being lifted by the lift device 5 is abruptly lost.

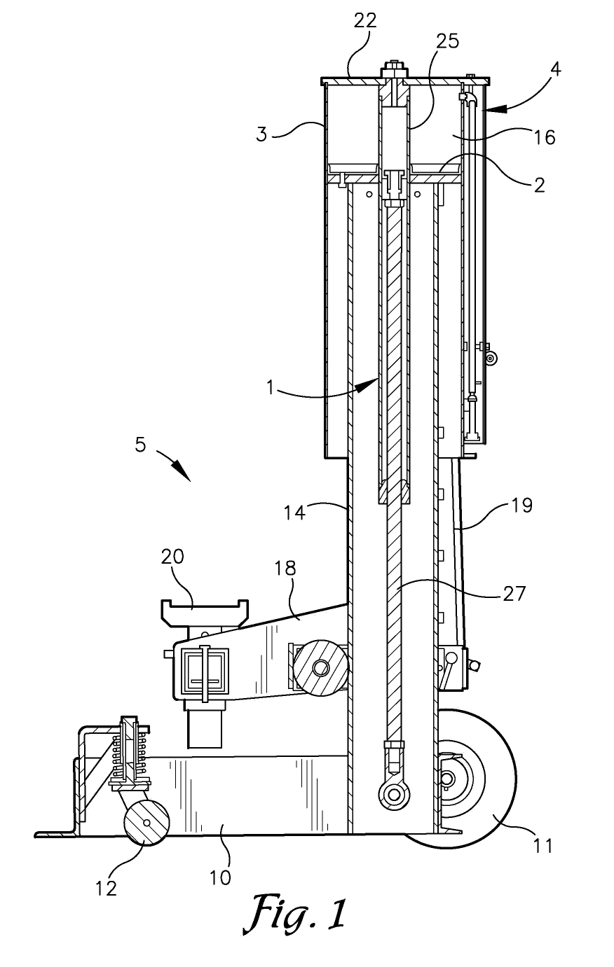

The illustrated end lift device 5 includes a base structure 10 (FIG. 1) including sets of wheels 11 and 12. A tubular base post 14 extends upwardly from the base 10, terminates in the pneumatic piston 2, and functions in a manner similar to a piston rod. The pneumatic cylinder 3 is sleeved on the piston 2 with an outer periphery of the piston 2 slidably and sealingly engaging an inner cylindrical surface of the cylinder 3 to form a pneumatic expansion chamber 16 therewith. The cylinder 3 has a lift carriage 18 connected thereto by a lift bracket 19 and includes a lift saddle 20 for engagement with a vehicle lift point. The lift carriage 18 moves with the cylinder 3. In a lowered position of the lift carriage 18, the pneumatic expansion chamber 16 is collapsed so that an end plate or wall 22 of the cylinder 3 is positioned close to the piston 2.

Compressed air is injected into the expansion chamber 16 to cause the cylinder 3 to extend relative to the stationary piston 2, thereby lifting the cylinder 3 and the lift carriage 18. By this means, the lift saddle 20, engaged with a vehicle lift point such as a vehicle bumper or the like (not shown), lifts an end of the vehicle. In order to lower the lift carriage 18, compressed air is slowly exhausted from the chamber 16. If the vehicle lift point should slip off the saddle 20, resistance to movement of the cylinder 3 is removed whereby the compressed air within the expansion chamber 16 suddenly expands causing the cylinder 3 to abruptly extend. Such a reaction can cause the lift device 5 to raise off the supporting floor or pavement. In order to prevent the sudden extension of the cylinder 3, the passive restraint strut apparatus 1 is incorporated within the cylinder 3.

The strut 1 illustrated in FIG. 1 has a strut cylinder 25 connected to the end plate 22 of the pneumatic cylinder 3 and a strut piston rod 27 connected to the tubular base post 14. The illustrated strut 1 is positioned coaxially within the pneumatic motor 4. It is foreseen that the strut 1 could be reversed, with the strut piston rod 27 connected to the pneumatic cylinder end plate 22 and the strut cylinder 25 connected to the tubular base post 14. Also, it is foreseen that the strut 1 could be mounted external to the cylinder 3 and the tubular base post 14. The strut 1 functions to enable gradual movement between the pneumatic cylinder 3 and the pneumatic piston 2 but to resist sudden extension of the cylinder 3, as will be described.

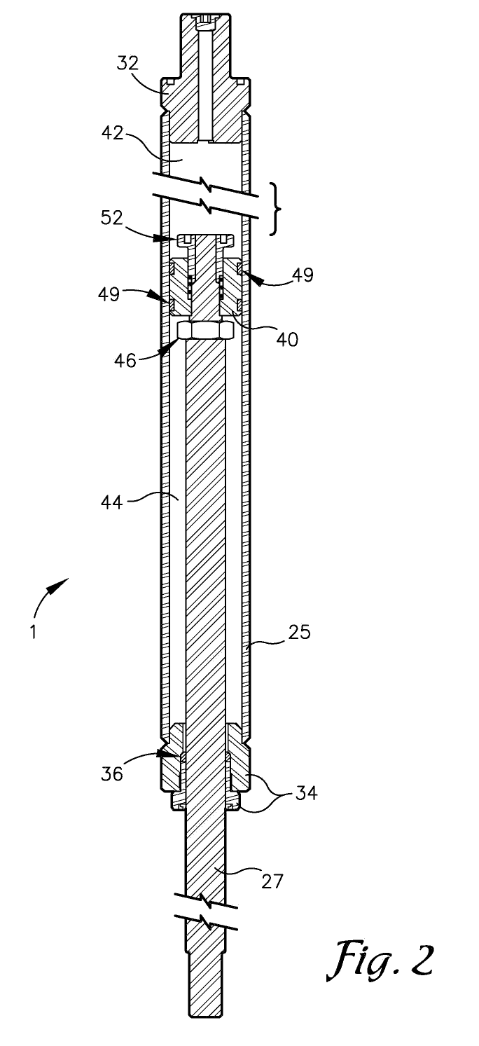

Referring to FIG. 2, the illustrated strut 1 includes a first end cap 32 which closes one end of the strut cylinder 25. An opposite end of the cylinder 25 is closed by a second end cap 34 which also makes sealing and sliding contact with the strut piston rod 27. The second end cap 34 includes a circular seal member 36 which engages the outer surface of the piston rod 27 to prevent the leakage of hydraulic fluid while allowing movement of the piston rod 27 into and out of the cylinder 25. Within the cylinder 25, a hydraulic piston 40, containing a valve biased from its seat by means such as a spring or by magnetic means, divides the cylinder 25 into a first chamber 42 and a second chamber 44. The chambers 42 and 44 are filled with a hydraulic fluid which flows from the second chamber 44 to the first chamber 42 through the piston 40 as the strut 1 extends and from the first chamber 42 to the second chamber 44 through the piston 40 as the strut 1 retracts. The piston rod 27 may include an extension stop member 46, such as the illustrated nut, to limit extension of the strut 1 by engagement of the stop nut 46 with the second end cap 34.

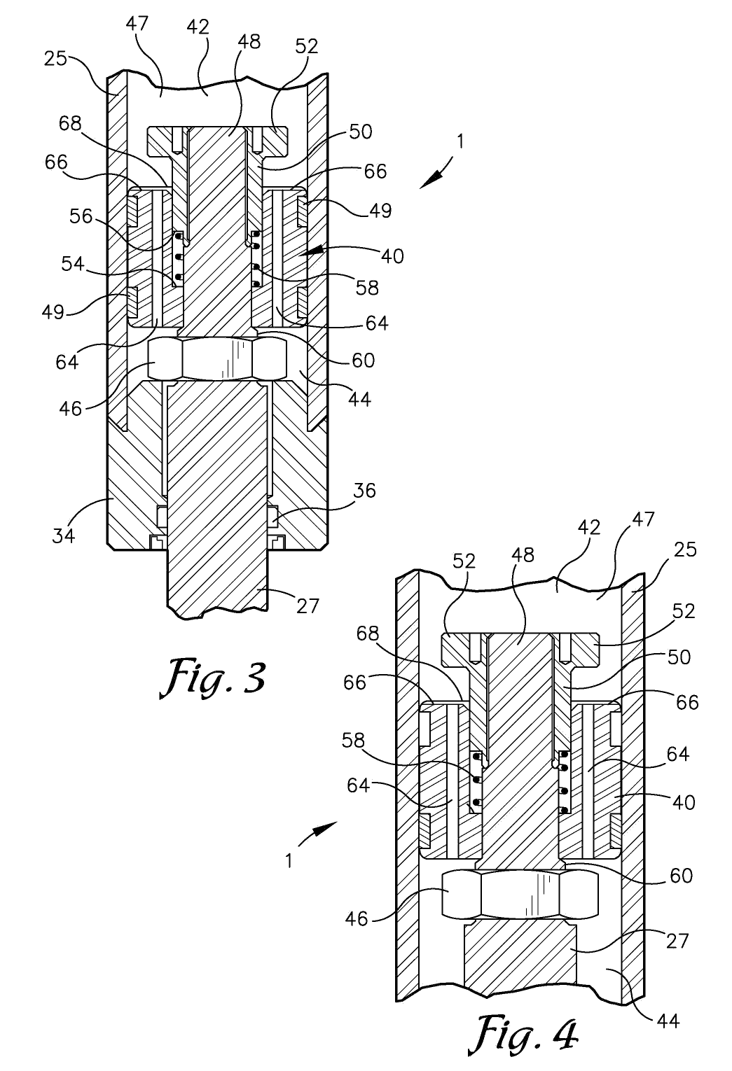

Referring to FIG. 3, the illustrated piston rod 27 terminates in a piston head stem 48 having a reduced diameter from that of the piston rod 27. The piston 40 has an annular shape and is sleeved onto the stem 48. The piston 40 may include guide rings 49 which engage an inner cylindrical surface 47 of the cylinder 25. A flange member 50 having a flange 52 extending radially from an end thereof is secured to the end of the stem 48 and extends through the piston 40. The piston 40 has an inwardly facing internal shoulder 54, while the flange member 50 has an outwardly facing shoulder 56. A compression spring 58 is sleeved on the stem 48, engaged between the shoulders 54 and 56, and normally urges the piston 40 away from the flange 52 and toward a stop shoulder 60 formed on the stem 48 in axially spaced relation to the flange 52. The piston 40 has a plurality of circumferentially spaced axial piston passages 64 formed therethrough. Each passage 64 has a radially extending groove 66 formed at an inner end thereof on an inner face 68 of the piston 40.

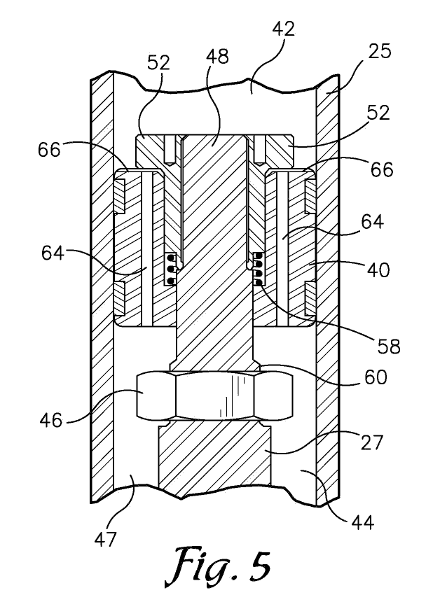

The number of piston passages 64 and their diameters are designed so that the aggregate cross sectional area of all the passages 64 provides flow rates through the piston 40 that do not interfere with gradual extension and retraction of the strut 1 during gradual extension and retraction of the piston rod 27. During such gradual extension and retraction of the piston rod 27, the piston 40 is maintained in its spaced apart relationship with the flange 52 by the force of the spring 58. This relationship is illustrated in FIG. 4 in which hydraulic fluid can flow freely between the chambers 42 and 44 through the piston 40. However, if the load on the lift saddle 20 is suddenly lost and the pneumatic cylinder 3 starts to suddenly extend, the passive restraint strut 1 is likewise urged to suddenly extend. Sudden extension of the strut 1 abruptly lowers the hydraulic pressure in the first chamber 42 and abruptly increases the pressure in the second chamber 44. This pressure differential on the floating piston 40 activates the passive restraint by overcoming the bias of the spring 58 and lifts the piston 40 into engagement with the flange 52 (FIG. 5). Engagement of the piston 40 with the flange 52 causes the piston passages 64 to be mostly occluded, thereby restricting the flow of hydraulic fluid through the piston 40. Restriction of the flow retards the extension of the strut 1 and, thus, the pneumatic cylinder 3, thereby preventing further uncontrolled extension of the cylinder 3 and possible jerking of the lift device 5 off the shop floor. Although the operation of the floating piston 40 is mainly attributable to a pressure differential between the chambers 42 and 44, it is also likely that frictional engagement of the piston 40 with the inner surface 47 of the cylinder 25 and inertia of the piston 40 itself can contribute to movement of the piston 40 into engagement with the flange 52 during sudden extension of the strut 1.

The grooves 66 communicate with the passages 64 and allow some flow of fluid through the piston 40 whereby the pneumatic cylinder 3 can continue to slowly rise until equilibrium between the pneumatic pressure within the cylinder 3 and the weight of the cylinder 3 and lift carriage 18 is reached. At this point, the force of the spring 58 overcomes any residual hydraulic pressure differential and urges the piston 40 away from the flange 52, thereby reopening the piston passages 64 and deactivating the passive restraint strut 1. The lift carriage 18 can then be lowered by exhausting the air from the pneumatic cylinder 3, and the vehicle intended to have an end lifted can be more carefully engaged by the lift saddle 20. It should be noted that loss of the load engaged by the lift saddle 20 is a rare and unplanned event. However, the floating piston 40 of the strut 1 can operate to damp sudden extension at any point along the stroke of the piston rod 27.

Although the passive restraint strut 1 has been illustrated and described with reference to restricting the sudden separation of two members, such as the sudden extension of the pneumatic motor 4, it is foreseen that the present invention could be applied to an arrangement to prevent sudden movement together of two members by reversing the functional elements of the floating piston 40, the flange 52, the spring 58, and the grooves 66. Additionally, it is foreseen that resistance to both sudden extension and sudden retraction could be handled by a bidirectional embodiment (not shown) of the present invention by positioning a floating piston 40 between two flanges and by using a bidirectional spring arrangement, or a pair of opposing springs, to urge the piston to an intermediate position between the flanges. In such a bidirectional arrangement, radial grooves similar to the grooves 66 would be formed on both ends of the floating piston.

While the passive restraint apparatus 1 of the present invention has been described with particular application to mobile upright vehicle end lift devices, it is foreseen that the arrangement could be adapted for other devices employing linear fluid motors and even for applications not involving linear motors.

It is to be understood that while certain forms of the present invention have been illustrated and described herein, it is not to be limited to the specific forms or arrangement of parts described and shown.

What is claimed and desired to secure by Letters Patent is:

1. A passive restraint damper strut apparatus for limiting sudden movement between a first member and a second member and comprising:
(a) a passive hydraulic damper including a hydraulic cylinder and a hydraulic piston rod, said damper being connected between said first member and said second member;
(b) a floating piston member mounted on said piston rod within said cylinder and slidably engaging said cylinder to divide said cylinder into a pair of hydraulic chambers;
(c) a hydraulic fluid positioned within said chambers;
(d) said piston member cooperating with said piston rod and said cylinder to enable substantially unrestricted flow of said fluid between said chambers in response to gradual relative movement between said first and second members; and
(e) said piston member cooperating with said piston rod and said cylinder to restrict flow of said fluid between said chambers in response to initiation of sudden relative movement between said first and second members to thereby prevent said sudden relative movement and to thereby enable controlled relative movement between said first and second members.

2. An apparatus as set forth in claim 1 wherein:
(a) said piston member has a fluid passage formed therethrough; and
(b) said piston member and said piston rod cooperate to at least partially close said fluid passage in response to said sudden relative movement.

3. An apparatus as set forth in claim 2 and including:
(a) a piston spring engaged between said piston member and said piston rod and normally urging said piston member to a position which avoids closing of said fluid passage.

4. An apparatus as set forth in claim 1 in combination with a pneumatic linear motor including a pneumatic cylinder, a pneumatic piston slidable within said pneumatic cylinder, and a pneumatic piston rod connected to said pneumatic piston and wherein:
(a) said hydraulic cylinder is connected to said pneumatic cylinder or said pneumatic piston rod and said hydraulic piston rod is connected to the other of said pneumatic piston rod and said pneumatic cylinder; and
(b) said passive restraint strut cooperates with said pneumatic linear motor in such a manner as to resist uncontrolled extension or retraction of said pneumatic linear motor.

5. An apparatus as set forth in claim 4 wherein:
(a) said passive restraint strut is positioned coaxially within said pneumatic linear motor.

6. An apparatus as set forth in claim 4 wherein:
(a) said pneumatic linear motor is a component of a vehicle end lift device.

7. A passive restraint strut apparatus for restraining uncontrolled linear movement between a first member and a second member and comprising:
(a) a hydraulic cylinder connected to said first member, said cylinder having a closed end and an opposite open end and including an internal cylinder surface;
(b) a piston rod connected to said second member and extending into said cylinder through said open end and slidably sealing said open end, said piston rod having a flange at an end thereof within said cylinder and a stop spaced axially from said flange;
(c) a piston sleeved on said piston rod to enable movement between said flange and said stop, said piston sealingly engaging said internal cylinder surface and having a piston passage extending therethrough between opposite ends thereof, said piston passage being sized and positioned in such a manner as to be restricted upon engagement of said piston with said flange and to otherwise enable relatively unrestricted flow therethrough, said piston dividing said cylinder into a first chamber and a second chamber;
(d) a hydraulic fluid filling said cylinder on opposite sides of said piston, said fluid flowing between said first and second chamber through said piston passage during relative movement between said cylinder and said piston;
(e) a spring engaged between said piston and said piston rod, said spring having a spring force sufficient to urge said piston in a direction away from said flange during substantially gradual movement between said cylinder and said piston rod; and
(f) said spring force being of such a strength as to be overcome in response to uncontrolled relative movement between said first and second members thereby enabling movement of said piston into engagement with said flange and restricting flow through said piston passage to thereby restrain relative movement between said cylinder and said piston rod in response to said uncontrolled relative movement between said first and second members.

8. An apparatus as set forth in claim 7 and including:
(a) a plurality of circumferentially spaced axial piston passages formed through said piston, said piston passages having such an aggregate cross sectional area as to avoid resistance to flow of hydraulic fluid therethrough during gradual relative movement between said first and second members and to create a differential pressure between said chambers to thereby overcome said spring force in response to sudden relative movement between said first and second members to thereby enable said movement of said piston into engagement with said flange.

9. An apparatus as set forth in claim 7 wherein:
(a) said spring force is overcome by a selected pressure differential on opposite ends of said piston.

10. An apparatus as set forth in claim 7 wherein:
(a) said spring force is overcome by frictional engagement of said piston with said cylinder in response to said uncontrolled relative movement.

11. An apparatus as set forth in claim 7 wherein:
(a) said spring force is overcome by inertia of the piston relative to the piston rod in response to said uncontrolled relative movement.

12. An apparatus as set forth in claim 7 wherein;
(a) said spring force is overcome by a combination of a selected pressure differential on opposite ends of said piston, frictional engagement of said piston with said cylinder, and inertia of the piston relative to the piston rod in response to said uncontrolled relative movement.

13. An apparatus as set forth in claim 7 wherein:
(a) said strut is adapted to restrain sudden linear movement between said first and second members during either extension or retraction of said piston rod relative to said cylinder.

14. An apparatus as set forth in claim 7 in combination with a pneumatic linear motor including a pneumatic cylinder, a pneumatic piston slidable within said pneumatic cylinder, and a pneumatic piston rod connected to said pneumatic piston and wherein:
(a) said cylinder of said strut is connected to said pneumatic cylinder or said pneumatic piston rod and said piston rod of said strut is connected to the other of said pneumatic piston rod and said pneumatic cylinder; and
(b) said strut cooperates with said pneumatic linear motor in such a manner as to resist sudden extension or retraction of said pneumatic linear motor.

15. An apparatus as set forth in claim 14 wherein:
(a) said strut is positioned coaxially within said pneumatic linear motor.

16. An apparatus as set forth in claim 14 wherein:
(a) said pneumatic linear motor is a component of a vehicle end lift device.

17. An apparatus as set forth in claim 7 in combination with a pneumatic linear motor including a pneumatic cylinder, a pneumatic piston slidable within said pneumatic cylinder, and a pneumatic piston rod connected to said pneumatic piston and wherein:
(a) said cylinder of said strut is connected to said pneumatic cylinder and said piston rod of said strut is connected to said pneumatic piston rod; and
(b) said strut cooperates with said pneumatic linear motor in such a manner as to resist sudden extension or retraction of said pneumatic linear motor.

18. A dynamically damped pneumatic lift apparatus for gradually lifting a load and for preventing uncontrolled extension of said lift apparatus in response to loss of said load from said lift apparatus at any location along an operating stroke of said lift apparatus and comprising:
(a) a floor engaging base;
(b) an elongated pneumatic piston rod upstanding from said base and terminating in a pneumatic piston;
(c) a pneumatic cylinder sleeved onto said pneumatic piston in sliding and sealing engagement therewith to form a pneumatic chamber with said pneumatic piston;
(d) a lift carriage connected to said pneumatic cylinder and adapted to engage a load to be lifted;
(e) said pneumatic cylinder cooperating with said pneumatic piston to lift said carriage in response to entry of compressed gas into said pneumatic chamber and to lower said carriage in response to exhaustion of said gas from said chamber to thereby define an operating stroke of said lift device;
(f) a hydraulic damper including a hydraulic cylinder and a hydraulic piston rod, said damper being connected between said pneumatic cylinder and said pneumatic piston rod;
(g) a floating piston member mounted on said hydraulic piston rod within said hydraulic cylinder and slidably engaging said hydraulic cylinder to divide said hydraulic cylinder into a pair of hydraulic chambers;
(h) a hydraulic fluid positioned within said hydraulic chambers;
(i) said floating piston member cooperating with said hydraulic piston rod and said hydraulic cylinder to enable substantially unrestricted flow of said fluid between said hydraulic chambers in response to gradual relative movement between said pneumatic cylinder and said pneumatic piston rod; and
(j) said floating piston member cooperating with said hydraulic piston rod and said hydraulic cylinder to restrict flow of said fluid between said hydraulic chambers in response to initiation of sudden relative movement between said pneumatic cylinder and said pneumatic piston rod to thereby prevent said sudden relative movement and to thereby enable only said gradual relative movement between said pneumatic cylinder and said pneumatic piston rod.

19. An apparatus as set forth in claim 18 wherein:
(a) said floating piston member has a fluid passage formed therethrough; and
(b) said floating piston member and said hydraulic piston rod cooperate to at least partially close said fluid passage in response to said sudden relative movement.

20. An apparatus as set forth in claim 19 and including:
(a) a piston spring engaged between said floating piston member and said hydraulic piston rod and normally urging said floating piston member to a position which avoids closing of said fluid passage.

21. An apparatus as set forth in claim 18 wherein:
(a) said hydraulic damper is positioned coaxially within said pneumatic cylinder and said pneumatic piston rod.

22. An apparatus as set forth in claim 18 and including:
(a) said floating piston having a plurality of piston fluid passages formed therethrough in circumferentially spaced relation;
(b) said hydraulic piston rod includes a piston rod flange, said floating piston being received on said hydraulic piston rod in spaced relation to said flange, said flange being sized and configured to at least partially restrict flow through said fluid passages upon engagement of said floating piston with said flange;
(c) a spring is positioned on said hydraulic piston rod and engages said hydraulic piston rod and said floating piston in such a manner as to resiliently urge said floating piston away from said flange during said gradual movement of said pneumatic cylinder relative to said pneumatic piston rod; and
(d) said floating piston being driven to engagement with said flange, thereby at least partially restricting flow through said fluid passages, in response to said sudden movement of said pneumatic cylinder relative to said pneumatic piston rod.
